(19) United States
(12) Patent Application Publication
(10) Pub. No.: US 2020/0356573 A1
(43) Pub. Date: Nov. 12, 2020

(54) The method of computers automatically match/couple the conditions and key elements/factors, is applied in the field of network.

(71) Applicant: BOLU (SHANGHAI) COMMERCIAL CONSULTING CO., LTD., Shanghai (CN)

(72) Inventors: Jianbo NI, Shanghai (CN); Qiuli WANG, Shanghai (CN)

(21) Appl. No.: 15/779,547

(22) PCT Filed: Jul. 4, 2017
(86) PCT No.: PCT/CN2017/000418

§ 371 Date: May 30, 2018

(30) Foreign Application Priority Data
Sep. 18, 2016 (CN) 201610837597.4

(51) Int. Cl. G06F 16/25; G06F 16/2458; G06F 16/27; G06F 16/28

(52) U.S. Cl. CPC G06F 16/252; G06F 16/284; G06F 16/27; G06F 16/2471

(57) ABSTRACT

Technique field: This innovative method is: Using generalized computer system (also including but not limited to, fixed or mobile intelligent computing multi-function device terminals) and its network system as the physical carrier, using computer technology and network technology, according to pre-designed logical rule calculations/operations and the diverse conditions, elements/factors, attributes, to automatically match and couple, to complete the core functions and purpose.

To solve the technical problem is that: Current technical methods, are often used for information displaying, manual participation in viewing/browsing and so on, to achieve low efficiency network behavior.

The key points of technical solutions for solving problems: Construct at least two or more queues or data pools, use automatic matching and coupling technical methods, and automatically generate matching-coupling results, which are automatically sent to various submitters and parties who may concern.

Its main uses are: not need parties to display information publicly, the platform system automatically matches and couples, and generates the performing results to notify various parties, what protects the privacy and confidentiality of both parties, improves the efficiency.

### TECHNIQUE FIELD

The Hardware and software technology of generalized computer system and network system, can be used selectively, which are the means and tools to implement this method. This method can even be implemented through computer technology and network technology innovations.

### TECHNIQUE BACKGROUND

With the continuous improvement, development and accumulation of computer hardware and software technology, network information technology is widely used in various industries and fields of society. Therefore various technical means and tools are available to implement this method. For example, submit independent data forms which are loaded/recorded a basket of diverse conditions, elements/factors and attributes to the two or more queues in the memory of the computer server system. According to the predesigned logical operations, the memory automatically matches and couples the conditions, elements/factors and attributes on the data forms.

### THE INVENTION CONTENTS

A method of using generalized computer system to automatically match and couple the diverse conditions, elements/factors and attributes, in the field of network systems. (Hereinafter referred to as this method)

The details of this method is: Using generalized computer system (also including but not limited to, fixed or mobile intelligent computing multi-function device terminals) and its network system as the physical carrier, using computer technology and network technology, according to pre-designed logical rule calculations/operations and the diverse conditions, elements/factors, attributes, to automatically match and couple. The performing results are generated automatically, and sent to various submitting parties and so on parties who may concern in various forms automatically, to complete the core functions and goals to be achieved.

This technical method can solve the following technical problems: At present, the existing technology methods, are often used for information displaying, manual participation in viewing/browsing and interconnected to achieve low efficiency network behavior by traditional technology methods. But the application of this innovative technical method, can achieve the high efficiency of matching/coupling and sending out the matching/coupling results automatically, without information displaying and manual participation in viewing/browsing.

The technical solution adopted to solve technical problems, please refer to the “Specific Implementation Method”, the beneficial effect of this method is that: in the case of not displaying information publicly, the platform system automatically matches and couples, automatically generates and sends the performing results, what protects the privacy and confidentiality of both parties, improves the efficiency and reduces the costs.

### ILLUSTRATE WITH DRAWING

FIG. 1 is a designed simplified diagram of this method.

FIG. 2 is a simplified diagram of computer technology sample for partial and specific implementation of this method. Adopted technology: Linux+J2EE (Struts2+Ibatis2)+MySQL database.

According to different industries fields applied and different innovative products manufactured, compared with other methods, this method will have the following comparative advantages and different characteristics: The authenticity and accuracy of the submitted information are high, the efficiency of the action achievement is high, the cost is low, and it is not limited by the conditions of time and space, and the sealed operation will not reveal any information and privacy.

### SPECIFIC IMPLEMENTATION MODE

1. The construction of narrowly-defined physical carrier: single or multiple servers form cluster and access to network system.

2. In the narrow sense, we list one kind of using existing software technology sample which is specific and typical as the specific instruction to achieve this method.

For example: In the case of using the B/S structure:

| | |
|---|---|
| backstage language | Java1.6 (JDK 6 above version) or C#, or .net, or |
| | php and so on languages |
| Backstage technology | MVC architecture, struts2+spring+mybatis, |
| architecture | jsp+fremarker and so on frames. |
| backstage caching | Use redis or memcached as the caching service |
| database | Sqlserver, or mysql5.5+redis and so on databases. |
| front desk technology | Html5, jquery, extjs, div, CSS, javascript and so on |
| | technologies. |
| Deployment plan | Nginx+tomcat6.0 Cluster deployment |
| tools | myEclipse2014 and so on tools environment. |
| Performance requirements | High concurrency, multi-threaded cache technology, |
| | cluster deployment and other technical means |

Submit independent data forms which are loaded/recorded a basket of diverse conditions, elements/factors and attributes to the memory of the computer server system. There are no restrictions on the quantity and content of conditions, elements/factors and attributes, and they can be designed and arranged as needed. In memory or other mediums with logical operations and storage functions, two queues are formed (or more than two queues may be designed or defined as data pools according to the actual situation) The numerous data forms submitted are submitted to and stored in two queues respectively according to the different roles of the submitter (a data form can only be in one queue at the same time, and can not exist in two queues at the same time). According to the pre-designed logical operation program (the logic operation program can be modified to improve and expand according to the actual situation) the diverse conditions elements/factors and attributes on two data forms respectively located in different queues are not stopped to automatically be matched and coupled until succeed. According to different business needs, each submitter can submit only one data form at a time, and also at the same time, they can submit a certain number of the same data forms at a time. The conditions, elements/factors and attributes on the data forms in the memory can be modified after the submission, before not successful of being matched and coupled. The data forms can be manually revoked, or the system can automatically cancel at regular intervals, or they can be automatically matched and coupled in the system memory queues for ever.

According to the pre-designed logical program, the system automatically matches and couples the conditions, elements/factors and attributes on the data forms in the two queues, and automatically generates the results, notifying the various parties who may submit the data forms or who may concern.

This method has specific applications of implementation products or platforms in many industries and fields, such as network job recruitment, network cash commodities exchange, network catering and social and so on.

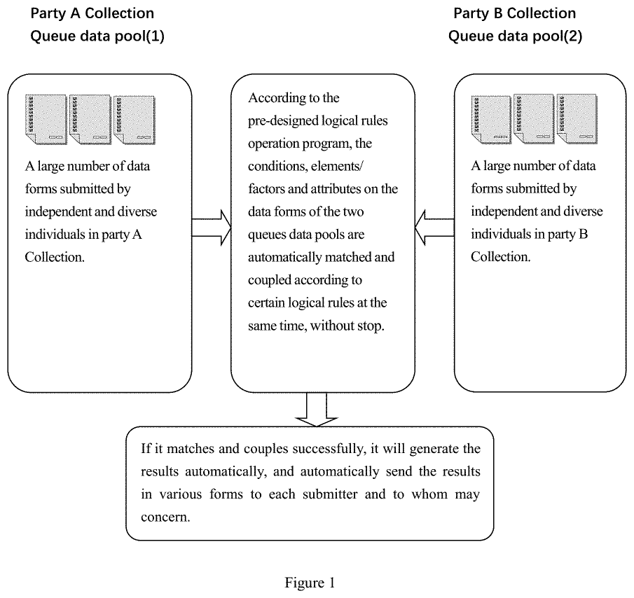

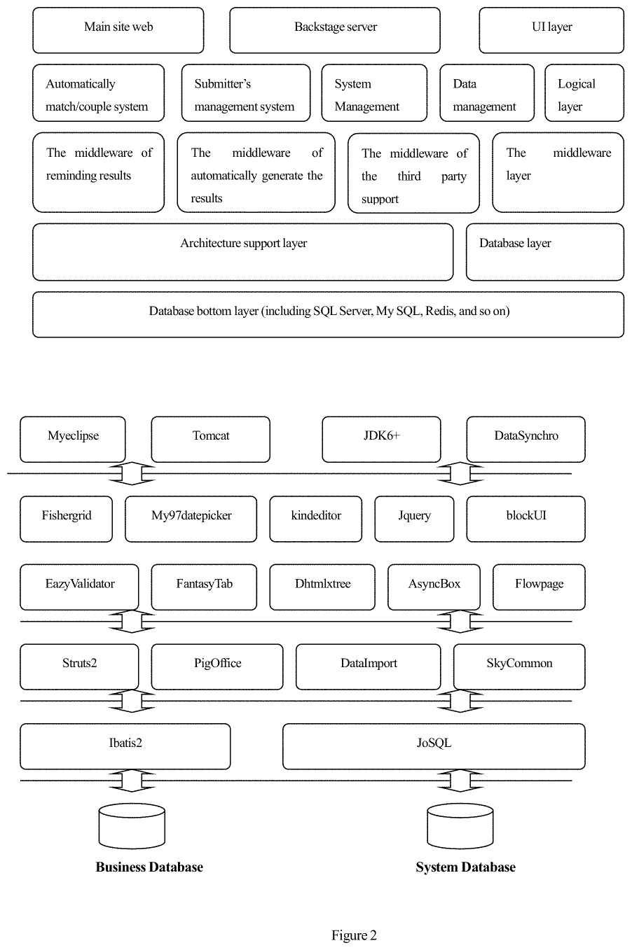

Please reference to FIG. 1, FIG. 2.

1. Using generalized computer system (also including but not limited to, fixed or mobile intelligent computing multi-function device terminals) and its network system as the physical carrier, using computer technology and network technology, according to pre-designed logical rule calculations/operations and the diverse conditions, elements/factors, attributes, to automatically match and couple. The performing results are generated automatically, and are sent to various submitting parties and so on parties who may concern in various forms automatically, to complete the core functions and goals to be achieved.
The technical features of this method is: Under the physical carrier system architecture and the program system designed architecture of the generalized computer and its network, (including but not limited to: B/S, C/S, MVC etc, two or more queues or data pools, memory logical operations, Redis, SQL Sever, Mysql databases etc, existing or technical innovation of computer technology and network technology to achieve this method) use professional and diverse conditions, elements/factors and attributes to match/couple by multi-logical operations automatically to achieve various functions and purposes in high efficiency.
The requirements of protection scope is:
It is required to protect the application of this method in the above fields of physical carrier, and required to protect any product and platform system which is based on the above mentioned physical carrier and manufactured by this method.
